(19) United States
(12) Patent Application Publication
(10) Pub. No.: US 2026/0171758 A1
(43) Pub. Date: Jun. 18, 2026

(54) MODULAR ELECTRICAL AND/OR DATA DISTRIBUTION RAIL SYSTEMS FOR RECONFIGURABLE VEHICLE INTERIORS

(71) Applicant: Textron Aviation, Inc., Wichita, KS (US)

(72) Inventors: Alexander Robert HUNT, Wichita, KS (US); Adam Ryan PAYTON, Wichita, KS (US)

(21) Appl. No.: 18/981,987

(22) Filed: Dec. 16, 2024

(51) Int. Cl. H02B 1/052; B64D 47/00; H02B 1/26

(52) U.S. Cl. CPC H02B 1/052; B64D 47/00; H02B 1/26; B64D 2221/00

(57) ABSTRACT

Modular electrical and/or data distribution rail systems include a rail assembly which defines a C-shaped channel track having an elongate front slot, and a plurality of electrical conductors carried by the elongate support structure. A modular connector pod assembly is provided with an H-shaped rear mounting member configured to be operatively connected to the rail assembly for sliding movements within the C-shaped channel track, and a front connector housing attached to the rear mounting member for housing at least one electrical and/or data port The rear mounting member includes an array of spring-biased pin connectors (e.g., so-called “pogo pins”) each establishing electrical contact with a respective one of the electrical conductors carried by the elongate support structure when the rear mounting member is operatively connected to the rail assembly. A temporary structural interface (TSI) module adapted to mount an accessory to the rail assembly may also be provided.

### FIELD

The embodiments disclosed herein relate generally to the field of electrical (e.g., AC and/or DC electrical power) and/or data distribution (e.g., analog or digital video, audio and/or data signals), that are usefully employed in reconfigurable vehicle interiors (e.g., reconfigurable aircraft cabins) to thereby allow flexibility in the placement of the electrical/data supply module in relation to passenger seat locations.

### BACKGROUND

A common challenge with vehicles that have flexible layouts or multiple mission capabilities is the need for electrical and/or data ports to be co-located with the seating location to provide convenient accessibility for the seat occupant. Typically, vehicles have poorly placed connections when configurations are flexible both at the time of delivery and when performing a mission since the locations of electrical/data ports are positionally fixed when the vehicle is manufactured.

For example, many aircraft owners and operators desire a cabin layout that can be flexibly rearranged to suit passengers and/or a particular aircraft mission. This typically involves the rearrangement of interior passenger seats along seat rails serving as attachment points on the floor of the aircraft cabin. Conventional fixed-position electrical and/or data ports in the aircraft interior cabin may therefore not be efficiently aligned with the passenger seat when the cabin interior is reconfigured.

This in turn leads to passenger discomfort and inconvenience when attempting to use the on-board electrical and/or data ports.

It would therefore be highly desirable if a modular data and/or power distribution rail system was provided that would more readily allow rearrangement of the electrical and/or data ports when the interior passenger seating is reconfigured. It is towards supply such a need that the embodiments disclosed herein are directed.

### SUMMARY

The embodiments disclosed herein are broadly concerned with allowing for electrical and/or data connectors to be positioned in ideal locations relative to passenger seating regardless of the vehicle interior layout configuration. In preferred embodiments, the modular electrical and/or data distribution rail systems will include a rail assembly which defines a C-shaped channel track having an elongate front slot, and a plurality of electrical conductors carried by the elongate support structure. A modular connector pod assembly is provided with an H-shaped rear mounting member configured to be operatively connected to the rail assembly for sliding movements within the C-shaped channel track, and a front connector housing attached to the rear mounting member for housing at least one electrical and/or data port The rear mounting member includes an array of spring-biased pin connectors (e.g., so-called “pogo pins”) each establishing electrical contact with a respective one of the electrical conductors carried by the elongate support structure when the rear mounting member is operatively connected to the rail assembly.

The elongate support track may comprise a generally U-shaped back shell member configured for fixed attachment to adjacent structure, and upper and lower front shell members fixed to upper and lower front edges of the back shell member, respectively, and defining therebetween the elongate front slot. The upper and lower front shell members may comprise a series of parallel grooves, wherein each of the electrical conductors is received within a respective one of the grooves.

The H-shaped rear mounting member according to some embodiments may include a forward mounting plate positioned within the C-shaped channel, a rearward mounting plates positioned adjacent to a forward surface of the rail assembly, and a central bridge member connecting the forward and rearward mounting plates. The central bridge member may define a wiring chase to allow wiring (e.g., associated with a wiring harness) to extend from the reward mounting plate and into the front connector housing for connection to the at least one electrical and/or data port housed therein.

The rail assembly is of indefinite length to accommodate the lengthwise (longitudinal) extent of the vehicle interior. A number of rail assembly sections may therefore be mounted end-to-end to achieve the desired lengthwise dimension. The rail assembly will preferably include end caps at opposed terminal ends thereof. A first (“live”) one of the end caps may thus be electrically connected to the electrical connectors and is adapted to be operatively interconnected with a wiring harness. A second (“dead”) one of the end caps may include a series of individual bosses that are sized and configured to be accepted within a respective one of the channels so as to press against terminal ends of the electrical conductors.

Certain embodiments may include a longitudinally split curtain covering the elongate front slot of the rail assembly. If provided, then the rear mounting member of the modular connector pod assembly may include wedge-shaped cam members extending longitudinally outwardly in opposite directions and located within the front slot when the modular connector pod assembly is operatively mounted within the C-shaped channel track. The cam members will thereby serve to separate the longitudinally split curtain in response to movement of the modular connector pod assembly along the rail assembly.

Some embodiments of the rail assembly may include upper and lower rectilinear gear tracks on a front surface of the elongate support structure, while the modular connector pod assembly includes upper and lower driven pinion gear assemblies each having a pinion gear meshed with a respective one of the upper and lower rectilinear gear tracks. One of upper and lower pinion gear assemblies may be motor-driven while the other one of the upper and lower pinion gear assemblies is a non-driven follower. The forward mounting plate of the H-shaped mounting member associated with the modular connector pod assembly may thus be provided with upper and lower elongate windows to allow the pinion gears of the upper and lower pinion gear assemblies to mesh with the upper and lower gear tracks. Operation of the driven pinion gear assembly will therefore cause the modular connector pod to be rectilinearly propelled along the elongate support structure so as to allow repositioning thereof.

Certain embodiments of the modular rail systems may include a temporary structural interface (TSI) module which is configured to mount an accessory to the rail assembly. The TSI module may therefore be comprised of a housing which includes a quick-disconnect socket assembly configured to receive a quick-disconnect pin associated with the accessory, an elongate back plate configured to be received within the elongate front slot of the support structure, and a pair of rotatable wing members rotatably attached to the elongate back plate. The wing members may therefore be turned between an unlocked condition whereby each of the wing members is aligned with an elongate axis of the front slot, and a locked condition whereby each of the wing members extends at substantially a right angle to the elongate axis of the front slot to thereby positionally lock the TSI module to the support structure of the rail assembly. The housing may be provided with tool sockets, each being operatively connected to a respective one of the wing members, which are configured to accept a turning tool therein to assist in the turning movements of the wing members between the unlocked and locked conditions thereof.

According to some embodiments, the TSI module may be electrified so as to provide electrical power to certain accessories, e.g., illuminated cupholders, wireless charging ports or the like. In this regard, the rotatable wing members of such electrified TSI modules may be provided with connector pins adapted to being brought into electrical connection with electrical power and ground conductors of the rail assembly when the wing members are in the locked condition thereof. An electrically conductive path may thus be provided in the housing of the TSI module so as to electrically interconnect the connector pins to the quick-disconnect socket so that electrical power can be supplied to an accessory in need of the same when the quick-disconnect pin associated with the accessory is inserted into the quick-disconnect socket.

These and other aspects and advantages of the present invention will become more clear after careful consideration is given to the following detailed description of the preferred exemplary embodiments thereof.

### BRIEF DESCRIPTION OF ACCOMPANYING DRAWINGS

The disclosed embodiments of the present invention will be better and more completely understood by referring to the following detailed description of exemplary non-limiting illustrative embodiments in conjunction with the drawings of which:

FIG. 1 is a schematic perspective illustration of a portion of an aircraft interior cabin which includes a modular data and/or power distribution rail system in accordance with an embodiment of this invention;

FIG. 2 is an enlarged perspective view of the modular data and/or power distribution rail system in accordance with an embodiment of this invention;

FIG. 3 is an enlarged perspective view of the modular data and/or power distribution rail system depicted in FIG. 2 shown with the terminal end cap and modular connector pod assembly disconnected from the rail assembly;

FIG. 4 is an exploded rear perspective view of the modular data and/or power distribution rail system depicted in FIG. 2;

FIG. 5 is a cross-sectional view as taken along lines 5-5 in FIG. 2; and

FIGS. 6A-6D are respectively a front perspective view, a rear perspective view, a side elevational view and a side perspective view of the modular connector pod assembly employed in the modular data and/or power distribution rail system in accordance with the invention;

FIG. 7 is an enlarged perspective view of the modular data and/or power distribution rail system in accordance with another embodiment of this invention;

FIGS. 8A and 8B are exploded front perspective views of the electro-mechanical drive system associated with the modular connector pod assembly employed in the modular data and/or power distribution rail system in accordance with the embodiment depicted in FIG. 7;

FIGS. 9A and 9B are front and rear perspective views, respectively, showing the TSI members exploded from the rail assembly of the modular data and/or power distribution rail system in accordance with the embodiment depicted in FIG. 7;

FIGS. 10A-10C are rear perspective views which depict a sequence by which an exemplary TSI member may operatively be coupled to the modular data and/or power distribution rail system; and

FIG. 11 is a cross-sectional elevational view of the TSI member shown in FIG. 7 as taken along line 11-11 therein.

### DETAILED DESCRIPTION OF EMBODIMENTS

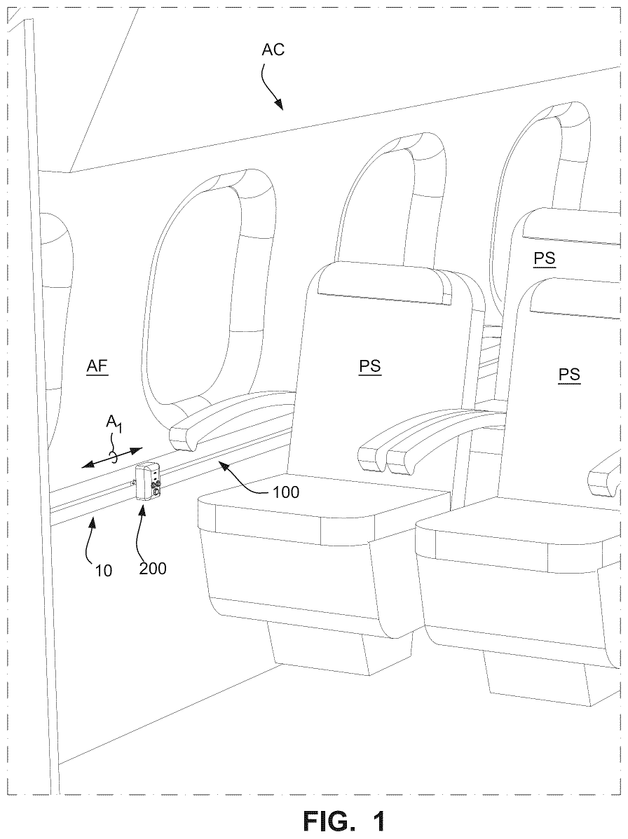

Accompanying FIG. 1 schematically depicts an aircraft cabin AC within the interior of the aircraft fuselage AF. As is conventional, the aircraft cabin AC may be provided with a number of passenger seats PS that can be arranged as desired by attachment to fixed-position floor rails (not shown). The passenger seats PS may thus be reconfigured to suit a particular owner or operator of the aircraft or to suit a specific mission need. By way of example only, the passenger seats PS may be positioned to be forward facing as shown in FIG. 1, or could be arranged with one pair of seats facing in an aft direction while and adjacent pair of seats faces in a forward direction (e.g., in a so-called club seating arrangement).

The aircraft interior shown in FIG. 1 importantly includes a modular electrical and/or data distribution rail system 10 in accordance with an embodiment of the invention. The rail system 10 is generally comprised of a rail assembly 100 and a modular connector pod assembly 200. As will be explained in greater detail below, the rail assembly is adapted and configured to being immovably fixed to a sidewall of the aircraft fuselage AF adjacent the passenger seats while the modular connector pod assembly 200 is configured to be movably connected to the rail assembly 100 so as to be capable of being slidably repositioned in fore and aft directions (arrow A1 in FIG. 1) along the rail assembly 100 to allow convenient location placement relative to a respective passenger seat PS.

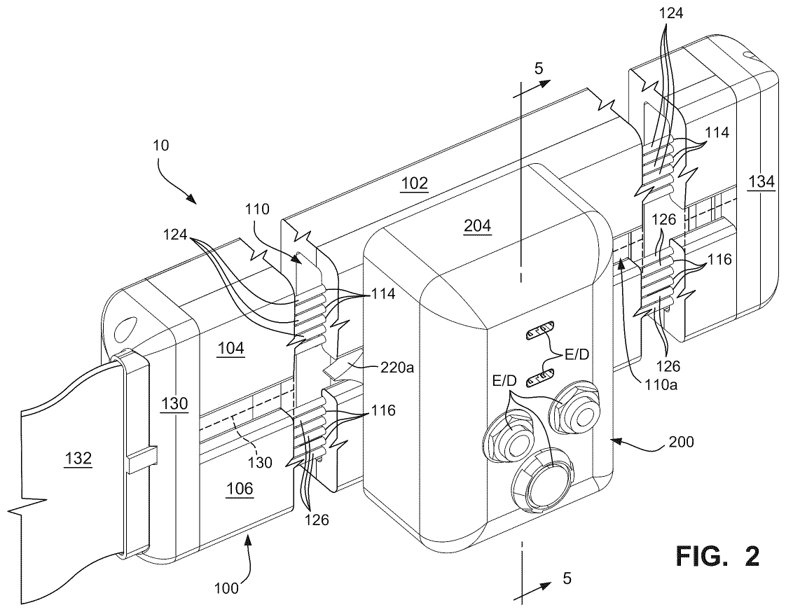

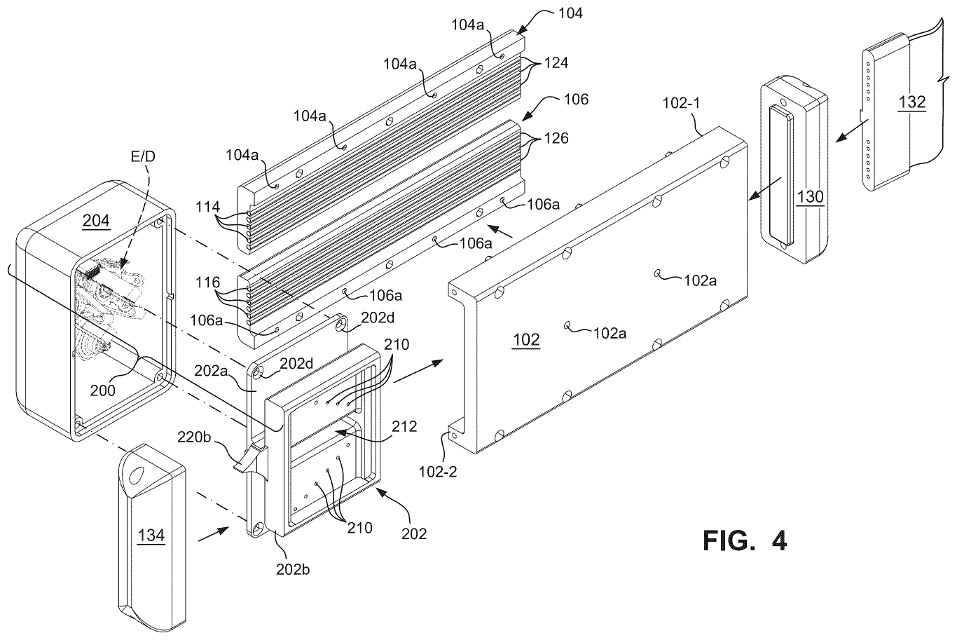

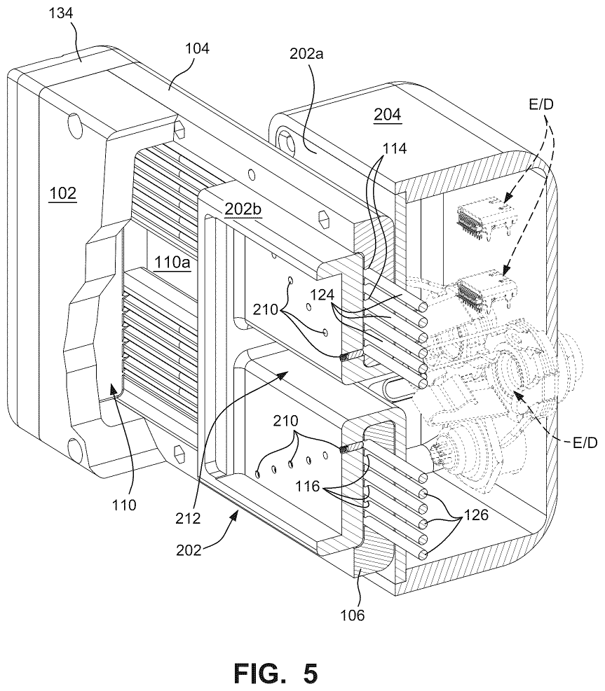

Accompanying FIGS. 2-5 depict the rail system 10 in an enlarged manner for greater clarity. As can be seen, the rail assembly 100 includes an elongate support structure that is generally comprised of a back shell member 102 that has mounting holes 102a (see FIG. 4) that allow direct fixed mounting to the side wall structure of the aircraft fuselage AF (e.g., via screws, rivets or the like). Upper and lower front shell members 104, 106, respectively, are fixed to the upper and lower front edges 102-1, 102-2 (see FIG. 4) of the back shell member 102. Such attachment is facilitated by the use of screws or other attachment devices extending through the holes 104a, 106a of the upper and lower front shell members 104, 106 which engage with the upper and lower front edges 102-1, 102-2 of the back shell member 102, respectively. Upon assembly of the upper and lower front shell members 104, 106 onto the back shell member 102, a generally C-shaped channel track 110 will thereby be established which defines a front slot 110a extending along the lengthwise direction of the rail assembly 100. A rear surface of each of the upper and lower front shell members 104, 106 defines a series of elongate parallel grooves (a representative few of which are identified in FIGS. 2-5 by reference numeral 114, 116, respectively) in which is disposed an electrical conductor (a representative few of which are identified in FIGS. 2-5 by reference numeral 124, 126, respectively).

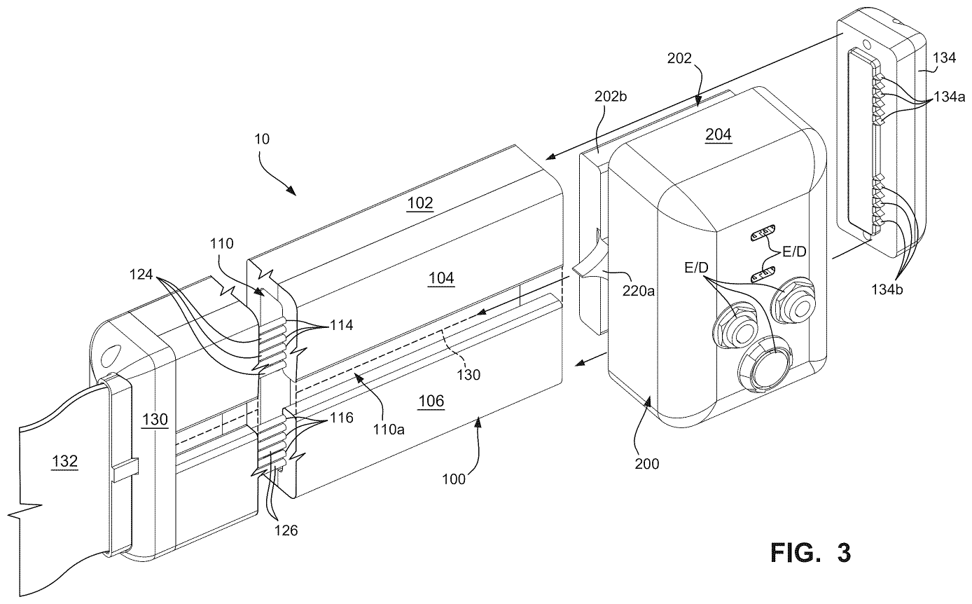

It will be appreciated that the rail assembly 100 will in practice have an indefinite length to suit the vehicle interior lengthwise dimension as may be required in use. One of the ends of the rail assembly 100 will include a “live” end cap 130 which includes terminal connectors (not shown) electrically connected to a respective one of the electrical conductors 124, 126 which can in turn be operatively interconnected with the pins of a wiring harness 132. The wiring harness 132 therefore establishes electrical connection between on-board systems (e.g., electrical power and/or data) and a respective one of the electrical conductors 124, 126 associated with the rail assembly 100. The opposite terminal end of the rail assembly 100 will therefore preferably include a “dead” end cap 134 which positionally retains the electrical conductors 124, 126 within their respective grooves 114, 116 but does not establish any electrical connection therewith, e.g., by individual bosses 134a, 134b (see FIG. 3) which are sized to be accepted within the channels 114, 116 of the upper and lower front shell members 104, 106 so as to press against the terminal ends of the conductors 124, 126, respectively.

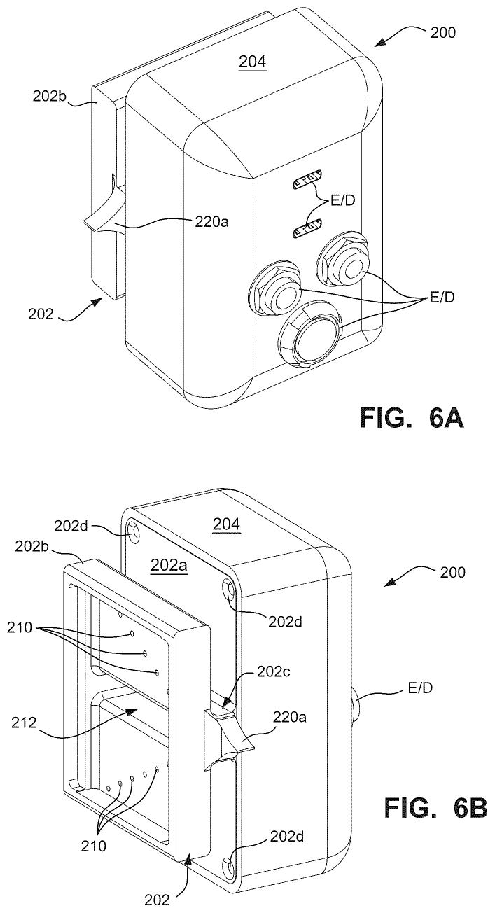

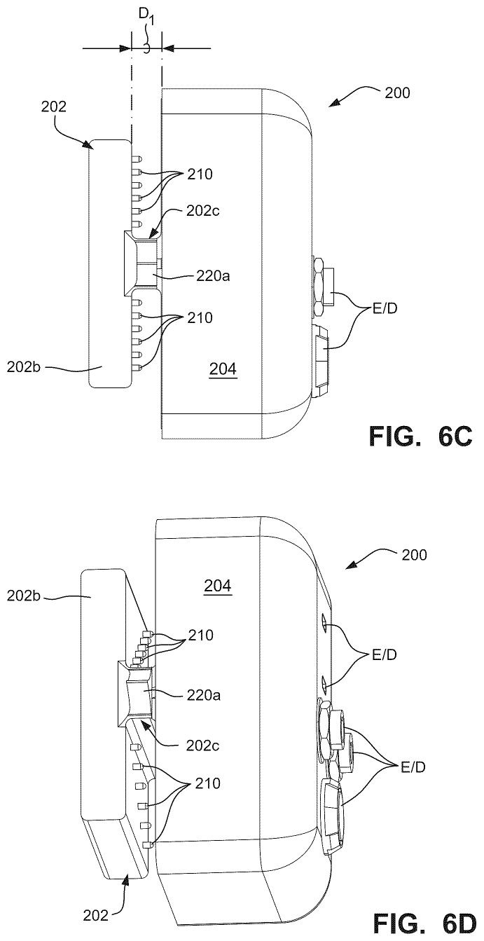

The modular connector pod assembly 200 is perhaps more clearly depicted in FIGS. 6A-6D. As shown therein, the modular connector pod assembly includes a generally H-shaped profiled rear mounting member 202 having forward and rearward mounting plates 202a, 202b that are connected integrally to one another by a central bridge member 202c. The bridge member 202c is sized and configured to be positionable within and slidable along the front slot 110a defined by the C-shaped channel track 110 and establishes a dimension D1 (see FIG. 6C) between the forward and rearward mounting plates 202a, 202b sufficient to be retained within the C-shaped channel track 110. Thus, while the rearward mounting plate 202b is sized and configured to be moveable within the C-shaped channel tack 110, the forward mounting plate 202a is preferably flush with the front surfaces of the upper and lower front shell members 104, 106, respectively, and slides therealong when the modular connector pod assembly 200 is moved relative to the rail assembly 100.

A front connector housing 204 is removably fixed to the rear connector housing 202, e.g., by means of screws or like fasteners within the mounting holes 202d of the forward mounting plate 202a (see FIG. 6B). The front connector housing 204 is provided so as to internally house the electrical and/or data connector ports (identified generically in FIGS. 6A-6D as E/D). A wide variety of electrical and/or data connector ports E/D may be provided depending on the needs of the vehicle operator and/or the vehicle mission. Thus, the modular connector pod assembly 200 may be configured with a variety of wiring protocols and connections including, but not limited to, USB-A, USB-B, USB-C, HDMI, Cat5, Cat6e, CANBUS, ARINC, stereo audio, 3-D audio, Bluetooth, Wi-Fi, NFC, barrel connectors, aviation headset plugs, powered headset jacks, MOLEX, DSUB, SJS and/or circular plastic connectors.

The rearward mounting plate 202b carries an array of spring-biased pin connectors (known colloquially in the art as “pogo pins”), a representative few of which are identified by reference numeral 210. Each of the pin connectors 210 is adapted and configured to contact a respective one of the electrical conductors 124, 126 positioned in the grooves 114, 116 of the upper and lower front shell members 104, 106, respectively. Each or a predetermined number of the pin connectors 210 will be electrically interconnected to a respective one of the electrical and/or data connector ports E/D within the housing 204 depending on the configuration of the modular connector pod assembly 200. Such electrical interconnection between the pin connectors 210 and the electrical and/or data connector ports E/D within the housing 204 is achieved by a wiring harness (not shown) having electrical conductors soldered to the pin connectors 210 at one end and extending through an internal wiring chase 212 formed in the central bridge member 202c so that the electrical conductors of the wire harness may be soldered to the electrical and/or data connector ports E/D within the housing 204.

The H-shaped profiled rear mounting member 202 may be provided with wedge-shaped cam members 220a, 220b which extend longitudinally outwardly in opposite directions and are located within the front slot 110a when the modular connector pod assembly 200 is operatively mounted within the C-shaped channel track 110. The cam members 220a, 220b thereby serve to separate a longitudinally split curtain (noted in dashed line by reference numeral 130 in FIGS. 2 and 3) that may optionally be provided so as to cover the front slot 110a in response to the modular connector pod assembly 200 being moved along the rail assembly 100 in the direction of arrow A1 (see FIG. 1).

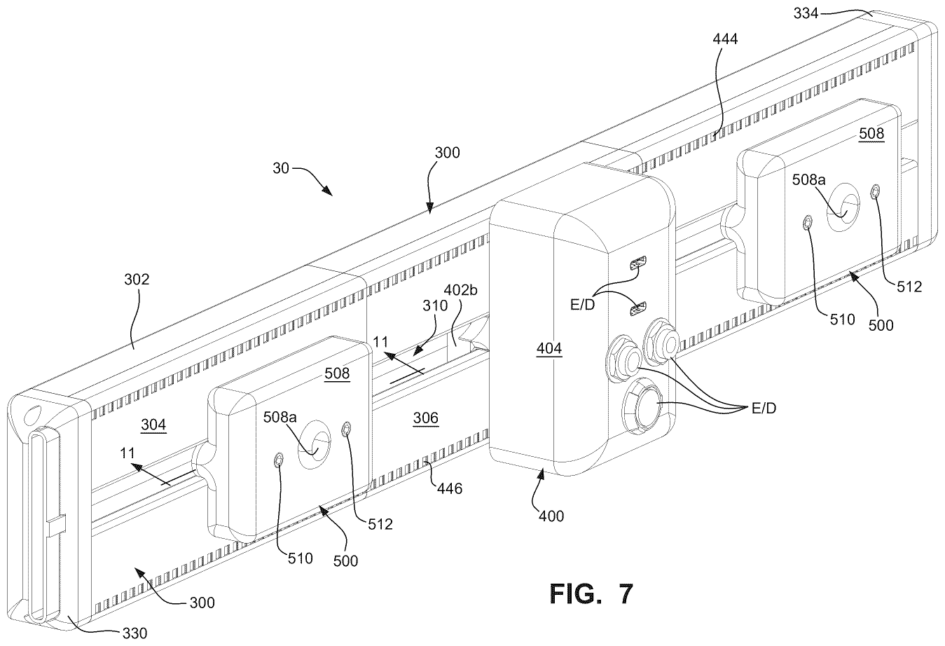

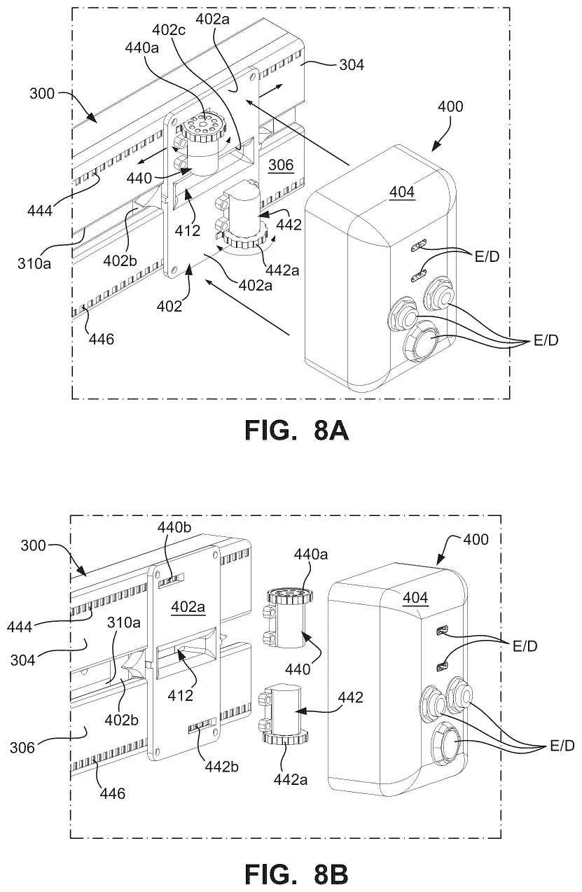

Another embodiment of a modular electrical and/or data distribution rail system 30 in accordance with the invention is shown in FIG. 7. Specifically, the rail system 30 is generally comprised of a rail assembly 300, a modular connector pod assembly 400 and temporary structural interface members 500. It will be appreciated that, while a single modular connector pod assembly 400 and a pair of temporary structural interface members 500 are depicted in FIG. 7, the rail system 30 may be provided with any number of modular connector pod assemblies 400 and/or structural interface members 500 as may be desired for any interior seating arrangement. Like the rail assembly 100 described previously, the rail assembly 300 is similarly adapted and configured to being immovably fixed to a sidewall of the aircraft fuselage AF adjacent the passenger seats while the modular connector pod assembly 400 is configured to be movably connected to the rail assembly 300 so as to be capable of being slidably repositioned in fore and aft directions along the rail assembly 300 to allow convenient location placement relative to a respective passenger seat PS (see arrow A1 in FIG. 1).

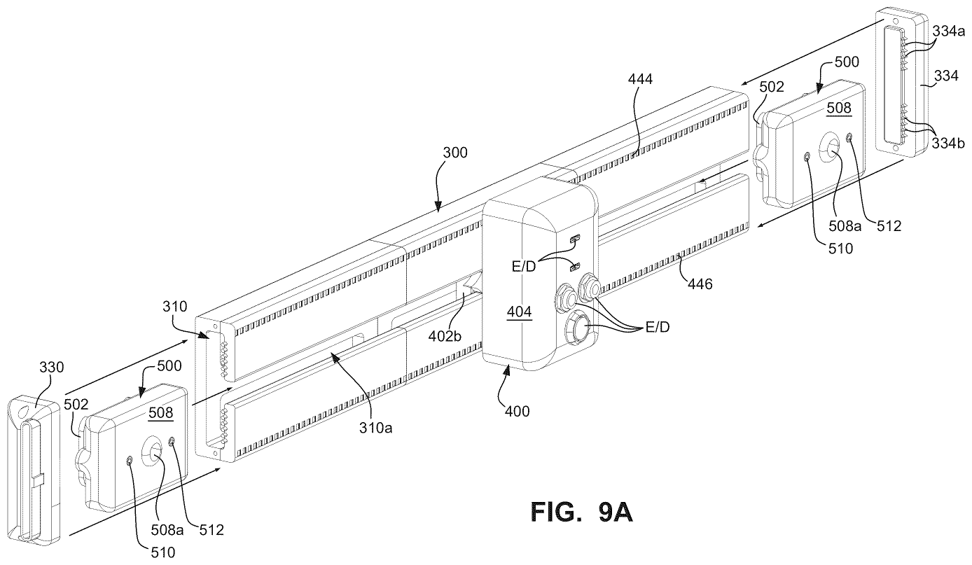

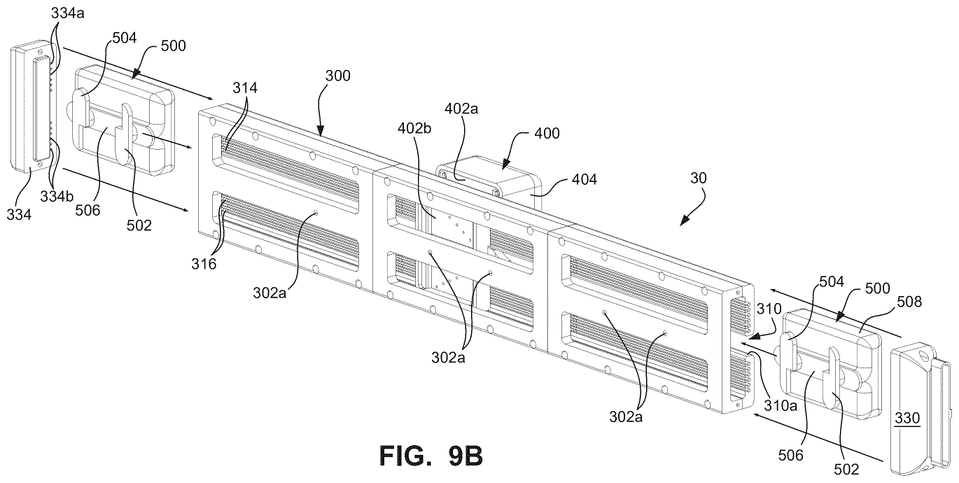

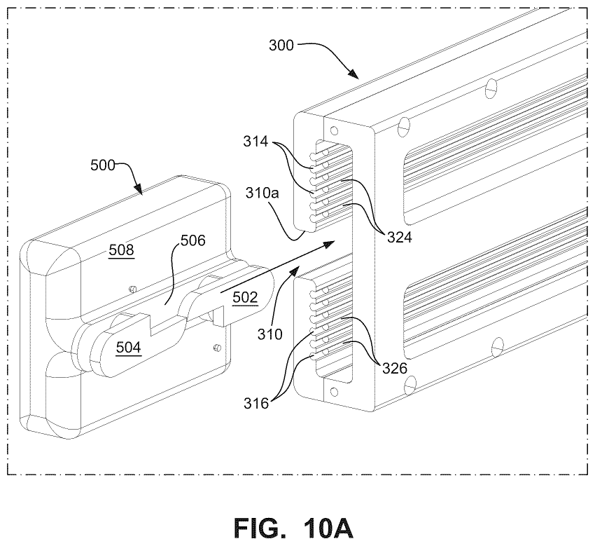

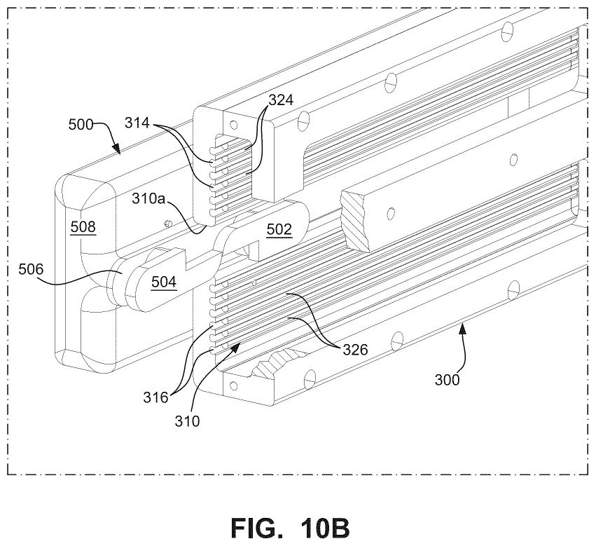

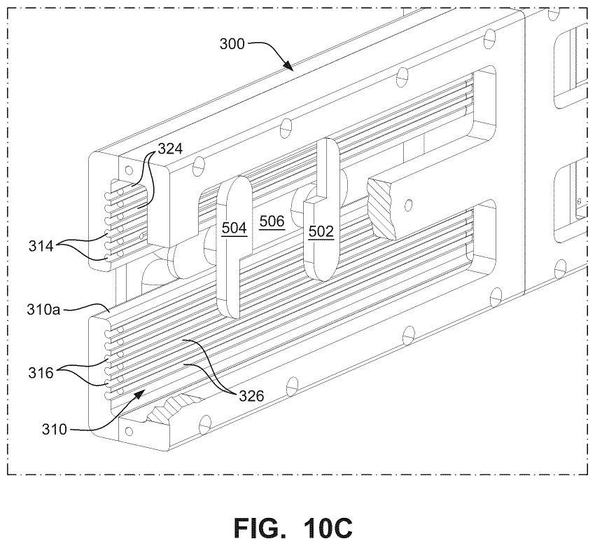

The rail assembly 300 includes an elongate support structure that is generally comprised of a back shell member 302 that has mounting holes 302a (see FIG. 9A) that allow direct fixed mounting to the side wall structure of the aircraft fuselage AF (e.g., via screws, rivets or the like). Upper and lower front shell members 304, 306, respectively, are fixed to the upper and lower front edges of the back shell member 302 in a manner similar to that described previously with the rail assembly 100. When assembled to the back shell member 302, therefore, the upper and lower front shell members 304, 306 will define a generally C-shaped channel track 310 establishing a front slot 310a extending along the lengthwise direction of the rail assembly 300. Similar to the rail assembly 100 described previously, the rear surface of each of the upper and lower front shell members 304, 306 may define a series of elongate parallel grooves (a representative few of which are identified in FIGS. 10A-10C by reference numerals 314, 316, respectively) in which is disposed a respective electrical conductor (a representative few of which are identified in FIGS. 10A-10C by reference numerals 324, 326, respectively).

The rail assembly 300 will include a “live” end cap 330 which includes terminal connectors (not shown) electrically connected to a respective one of the electrical conductors 324, 326 which can in turn be operatively interconnected with the pins of a wiring harness (not shown in FIG. 7 but see wiring harness 132 in FIG. 2). The wiring harness therefore establishes electrical connection between on-board systems (e.g., electrical power and/or data) and a respective one of the electrical conductors 324, 326 associated with the rail assembly 100. The opposite terminal end of the rail assembly 300 will therefore preferably include a “dead” end cap 334 which positionally retains the electrical conductors 124, 126 within their respective grooves 314, 316 but does not establish any electrical connection therewith, e.g., by individual bosses 334a, 334b which are sized to be accepted within the channels 314, 316 of the upper and lower front shell members 304, 306 so as to press against the terminal ends of the conductors 324, 326, respectively.

The modular connector pod assembly 400 is perhaps more clearly depicted in FIGS. 8A and 8B. In this regard, the modular connector pod assembly may be structurally similar to the modular connector pod assembly 200 discussed previously in that it includes a generally H-shaped profiled rear mounting member 402 having forward and rearward mounting plates 402a, 402b that are connected integrally to one another by a central bridge member 402c. The bridge member 402c is sized and configured to be positionable within and slidable along the front slot 310a defined by the C-shaped channel track 310 and establishes a predetermined dimension between the forward and rearward mounting plates 402a, 402b sufficient to be retained within the C-shaped channel track 310. Thus, while the rearward mounting plate 402b is sized and configured to be moveable within the C-shaped channel tack 310, the forward mounting plate 402a is preferably flush with the front surfaces of the upper and lower front shell members 104, 106, respectively, and slides therealong when the modular connector pod assembly 400 is moved relative to the rail assembly 300. The bridge member 402c also preferably defines an internal wiring chase 412 to allow electrical conductors of a wiring harness (not shown) to be soldered to the electrical and/or data connector ports E/D within the housing 404 of the modular connector pod assembly 400 and thereby establish electrical connection pin connectors (not shown) associated with the rearward mounting plate 410.

The modular connector pod assembly 400 importantly include upper and lower diagonally opposed pinion gear assemblies 440, 442 each of which includes a pinion gear 440a, 442a which extends through an elongate window 440b, 442b formed in the forward mounting plate 402a so as to be intermeshed with a rectilinear gear track 444, 446 integrally formed on the upper and lower front shell members 304, 306, respectively. One of the upper and lower diagonally opposed pinion gear assemblies 440, 442 may be driven (e.g., via a DC electric motor) while the other may be undriven (follower). Both such pinion gear assemblies 440, 442 may however be driven if desired. When assembled, therefore, the driven one(s) of the pinion gear assemblies 440, 442 may thus be operated in use so as to propel the modular connector pod assembly 400 rectilinearly along the lengthwise extent of the rail assembly 300 to achieve desired location of the former relative to the latter.

The distance traveled by the modular connector pod assembly 400 may be calculated by either counting (e.g., via an electromechanical counter) the number of rotations by a fixed circumference gear translating to a linear distance traveled, or measuring resistance along a dedicated resistive strip in the rail assembly 300 (not shown) and then translating changes in the measured resistance to a specific defined location along the axis. To define the layout of modular connector pod assemblies 400 along the axis of the rail assembly 300, a set number of predefined locations for each vehicle configuration could be provided which are stored in the management system and can be recalled to the set locations when commanded by the controller (not shown). For custom layouts, a learning mode may be attained by removing power and manually locating the modular pods along the axis. When power is restored, the locations modular connector pod assemblies 400 along the axis of the rail assembly 300 may then be saved in non-volatile memory of the controller as a custom configuration.

Certain vehicle interior layouts may also require the positioning of various seat and/or passenger comfort accessories, e.g., cup holders, magazine holders, foldable tray tables and the like. In order to accommodate such accessories, the rail system 300 (or even the rail system 100 previously discussed) may be provided with temporary structural interface (TSI) members 500 as may be required. As is shown more clearly in FIGS. 9A-10C, each TSI module 500 is constructed of a high tensile strength material that is non-conductive and is adapted to interface with the rail assembly 300 so as to provide a temporary mounting structure for aircraft accessories that do not require electrical power. In this regard, the TSI module 500 is provided with an aligned pair of quarter turn wing members 502, 504 that are rotatably mounted to an elongate back plate 506 of the housing 508.

The front or cabin face of the housing 508 is provided with a quick-disconnect socket assembly 508a that allows for a variety of accessories to be temporarily mounted to the TSI module 500 at any location along the rail assembly 300. Depending on the size and weight of the accessory, either one TSI module 500 or a grouping of multiple TSI members 500 may be provided and positioned along the rail assembly 300 so that quick-disconnect pins (not shown) associated with such accessories may be coupled to the TSI member(s) by means of the quick-disconnect socket assembly 508a.

The back plate 506 is sized and configured so as to be accommodated within the front slot 310a of the C-shaped channel track 310 and be slidably rectilinearly therealong so as to position the TSI module 500 along the rail assembly 300. The wing members 502, 504 may thus be rotatably moveable between an unlocked condition whereby each of the wing members 502, 504 is aligned with the elongate axis of the front slot 310a (see FIGS. 10A and 10B) and a locked condition whereby each of the wing members extend at substantially a right angle to the elongate axis of the front slot 310A (see FIG. 10C). When in the locked condition, therefore, the TSI module 500 will be positionally fixed along the rail assembly 300. The wing members 502, 504 may be rotatably turned between the unlocked and locked conditions by cooperative interaction between a turning tool (e.g., screw driver, keyed wrench (e.g., hex key) or the like) and a respective conformably configured socket 510, 512 accessible on the front face of the housing 508.

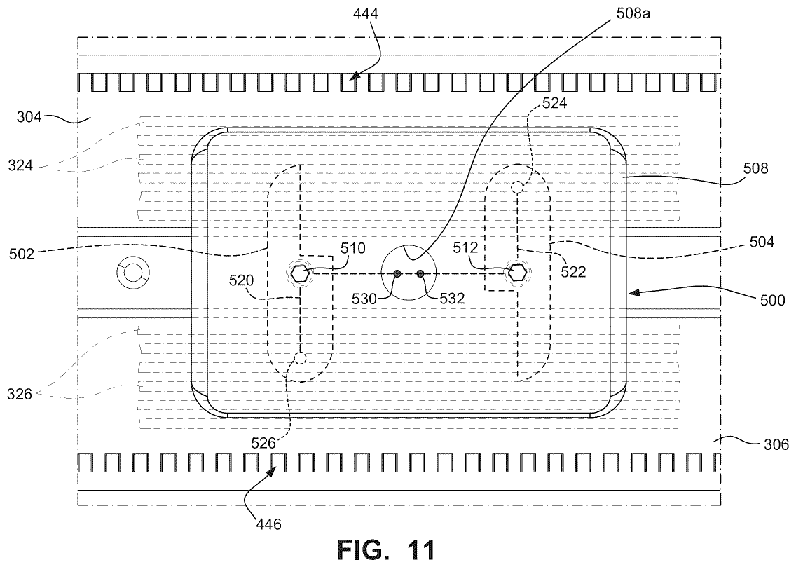

Should power be required by the accessory for items such as illuminated cupholders, wireless charging ports or the like, electrically conductive paths 520, 522 (e.g., embedded wires or deposited traces formed of an electrically conductive material) may be added between pogo pin connectors 524, 526 associated with the wing members 502, 504 and contacts 530, 532 associated with the quick-disconnect socket assembly 508a of the TSI module 500. The connectors 524, 526 are thereby adapted and configured to contact a respective one of the conductors 324, 326 serving as electrical power supply and ground wires, respectively, within the rail assembly 300 when the wing members 502, 504 are pivotally moved into the locked condition thereof as shown in FIG. 11. The quick-disconnect pin (not shown) associated with the desired accessory to be supported by the TSI module 500 will thereby complete the circuit to illuminate any lighting associated with such accessory. In such a manner, therefore, the TSI module 500 may suitably be employed to provide a convenient way to not only structurally support passenger seat accessories, but also to provide electrical interconnection with the illumination features associated with such accessories.

While reference has been made to particular embodiments of the invention, various modifications within the skill of those in the art may be envisioned. Therefore, it is to be understood that the invention is not to be limited to the disclosed embodiments, but on the contrary, is intended to cover various modifications and equivalent arrangements included within the spirit and scope thereof.

What is claimed is:

1. A modular electrical and/or data distribution rail system comprising:
a rail assembly which includes an elongate support structure which includes a C-shaped channel track defining an elongate front slot, and a plurality of electrical conductors carried by the elongate support structure; and
a modular connector pod assembly which includes an H-shaped rear mounting member configured to be operatively connected to the rail assembly for sliding movements within the C-shaped channel track, and a front connector housing attached to the rear mounting member for housing at least one electrical and/or data port, wherein
the rear mounting member includes an array of spring-biased pin connectors each establishing electrical contact with a respective one of the electrical conductors carried by the elongate support structure when the rear mounting member is operatively connected to the rail assembly.

2. The modular electrical and/or data distribution rail system according to claim 1, wherein the elongate support track comprises:
a back shell member configured for fixed attachment to adjacent structure; and
upper and lower front shell members fixed to upper and lower front edges of the back shell member, respectively, and defining therebetween the elongate front slot.

3. The modular electrical and/or data distribution rail system according to claim 2, wherein the upper and lower front shell members comprise a series of parallel grooves, wherein each of the electrical conductors is received within a respective one of the grooves.

4. The modular electrical and/or data distribution rail system according to claim 1, wherein H-shaped rear mounting member includes:
a rearward mounting plate positioned within the C-shaped channel,
a forward mounting plate positioned adjacent to a front surface of the elongate support structure, and
a central bridge member connecting the forward and rearward mounting plates.

5. The modular electrical and/or data distribution rail system according to claim 4, wherein the central bridge member defines a wiring chase to allow wiring to extend from the reward mounting plate and into the front connector housing for connection to the at least one electrical and/or data port housed therein.

6. The modular electrical and/or data distribution rail system according to claim 3, wherein the rail assembly is of indefinite length and includes end caps at opposed terminal ends thereof.

7. The modular electrical and/or data distribution rail system according to claim 6, wherein a first one of the end caps is electrically connected to the electrical connectors and is adapted to be operatively interconnected with a wiring harness.

8. The modular electrical and/or data distribution rail system according to claim 7, wherein a second one of the end caps includes a series of individual bosses that are sized and configured to be accepted within a respective one of the channels so as to press against terminal ends of the electrical conductors.

9. The modular electrical and/or data distribution rail system according to claim 1, further comprising a longitudinally split curtain covering the elongate front slot of the rail assembly.

10. The modular electrical and/or data distribution rail system according to claim 9, wherein the rear mounting member of the modular connector pod assembly further includes wedge-shaped cam members which extend longitudinally outwardly in opposite directions and are located within the front slot when the modular connector pod assembly is operatively mounted within the C-shaped channel track, the cam members serving to separate the longitudinally split curtain in response to movement of the modular connector pod assembly along the rail assembly.

11. The modular electrical and/or data distribution rail system according to claim 1, wherein
the rail assembly comprises at least one rectilinear gear track on a front surface of the elongate support structure, and wherein
the modular connector pod assembly comprises at least one driven pinion gear assembly having a pinion gear meshed with the at least one rectilinear gear track such that operation of the at least one driven gear assembly propels the modular connector pod rectilinearly along the elongate support structure.

12. The modular electrical and/or data distribution rail system according to claim 11, wherein
the H-shaped rear mounting member includes a forward mounting plate positioned adjacent to the front surface of the elongate support structure, and wherein
the forward mounting plate defines an elongate window aligned with the at least one rectilinear gear track, and wherein
the at least one pinion gear extends through the elongate window of the forward mounting plate so as to be meshed with the at least one rectilinear gear track.

13. The modular electrical and/or data distribution rail system according to claim 1, wherein
the rail assembly comprises upper and lower rectilinear gear tracks on a front surface of the elongate support structure which parallel the elongate front slot, and wherein
the modular connector pod assembly comprises upper and lower pinion gear assemblies each having a pinion gear meshed with a respective one of the upper and lower rectilinear gear tracks, wherein
the pinion gear of at least one of the upper and lower pinion gear assemblies is driven such that operation of the driven pinion gear of the at least one of the upper and lower pinion gear assemblies propels the modular connector pod rectilinearly along the elongate support structure.

14. The modular electrical and/or data distribution rail system according to claim 13, wherein the pinion gear of a second one of the upper and lower pinion gear assemblies is an undriven follower pinion gear.

15. The modular electrical and/or data distribution rail system according to claim 13, wherein
the H-shaped rear mounting member includes a forward mounting plate positioned adjacent to the front surface of the elongate support structure, and wherein
the forward mounting plate defines upper and lower elongate windows aligned with the upper and lower rectilinear gear tracks, and wherein
the pinion gears of the upper and lower pinion gear assemblies extend through the upper and lower elongate windows of the forward mounting plate so as to be meshed with the upper and lower rectilinear gear tracks, respectively

16. The modular electrical and/or data distribution rail system according to claim 15, wherein the pinion gear of a first one of the upper and lower pinion gear assemblies is motor-driven, and the pinion gear of a second one of the upper and lower pinion gear assemblies is an undriven follower gear.

17. The modular electrical and/or data distribution rail system according to claim 1, further comprising a temporary structural interface (TSI) module adapted to mount an accessory to the rail assembly, wherein the TSI module comprises:
(i) a housing which includes a quick-disconnect socket assembly configured to receive a quick-disconnect pin associated with the accessory,
(ii) an elongate back plate configured to be received within the elongate front slot of the support structure, and
(iii) a pair of rotatable wing members rotatably attached to the elongate back plate to allow for turning movements between an unlocked condition whereby each of the wing members is aligned with an elongate axis of the front slot and a locked condition whereby each of the wing members extends at substantially a right angle to the elongate axis of the front slot to thereby positionally lock the TSI module to the support structure of the rail assembly.

18. The modular electrical and/or data distribution rail system according to claim 17, wherein the housing comprises tool sockets each being operatively connected to a respective one of the wing members, the tool sockets being configured to accept a turning tool therein to assist in the turning movements of the wing members between the unlocked and locked conditions thereof.

19. The modular electrical and/or data distribution rail system according to claim 18, wherein
one of the electrical conductors of the rail assembly is an electrical power conductor and another one of the electrical conductors of the rail assembly is an electrical ground conductor, and wherein
each of the rotatable wing members comprise connector pins adapted to being connected to the one and another of the electrical conductors when the wing members are in the locked condition thereof, and wherein
the housing member comprises an electrically conductive path to electrically interconnect the connector pins to the quick-disconnect socket assembly to thereby provide electrical power to the accessory when the quick-disconnect pin thereof is connected to the quick-disconnect socket.

20. An aircraft comprising a fuselage including an interior aircraft cabin which comprises the modular electrical and/or data distribution rail system according to claim 1.

21. A modular electrical and/or data distribution rail system comprising:
a rail assembly, and
a modular connector pod assembly operatively associated with the rail assembly, wherein
the rail assembly comprises:
rear shell member adapted to being fixed to adjacent structure, and
opposed upper and lower front shell members establishing a front surface of the rail assembly, wherein
the upper and lower front shell members are separated from one another and attached to upper and lower edges, respectively, of the rear shell member, and wherein
the rear shell member and the upper and lower shell members collectively define a C-shaped channel track having an elongate front slot, and wherein
the upper and lower front shell members comprise (1) a series of parallel grooves, and (2) a plurality of electrical conductors positioned within respective ones of the grooves, and wherein
the modular connector pod assembly comprises:
an H-shaped rear mounting member configured to be operatively connected to the rail assembly to allow for sliding movements within the C-shaped channel track and along the front surface of the rail assembly, the H-shaped rear mounting member integrally including:
(i) a rearward mounting plate positioned within the C-shaped channel,
(ii) a forward mounting plate positioned adjacent to the front surface of the rail assembly, and
(iii) a central bridge member connecting the forward and rearward mounting plates, the central bridge member defining a wiring chase therethrough, and
a front connector housing attached to the forward mounting plate of the H-shaped rear mounting member for housing a plurality of electrical and/or data ports, wherein
the rearward mounting plate of the H-shaped rear mounting member includes an array of pin connectors each establishing electrical contact with a respective one of the electrical conductors positioned within a respective one of the grooves of the upper and lower front shell members and being electrically interconnected with a respective one of the plurality of electrical and/or data ports housed within the front connector housing.

22. The modular electrical and/or data distribution rail system according to claim 21, wherein the pin connectors are spring biased pogo pins.

23. The modular electrical and/or data distribution rail system according to claim 21, wherein the rail assembly is of indefinite length and includes end caps at opposed terminal ends thereof.

24. The modular electrical and/or data distribution rail system according to claim 23, wherein a first one of the end caps is electrically connected to the electrical connectors and is adapted to be operatively interconnected with a wiring harness.

25. The modular electrical and/or data distribution rail system according to claim 24, wherein a second one of the end caps includes a series of individual bosses that are sized and configured to be accepted within a respective one of the channels so as to press against terminal ends of the electrical conductors.

26. The modular electrical and/or data distribution rail system according to claim 21, wherein
the upper and lower front shell members include respective upper and lower rectilinear gear tracks on the front surface of rail assembly which parallel the elongate front slot thereof, and wherein
the modular connector pod assembly comprises upper and lower pinion gear assemblies each having a pinion gear meshed with a respective one of the upper and lower rectilinear gear tracks, wherein
the pinion gear of at least one of the upper and lower pinion gear assemblies is driven such that operation of the driven pinion gear of the at least one of the upper and lower pinion gear assemblies propels the modular connector pod rectilinearly along the elongate support structure

27. The modular electrical and/or data distribution rail system according to claim 26, wherein the pinion gear of a second one of the upper and lower pinion gear assemblies is an undriven follower pinion gear.

28. The modular electrical and/or data distribution rail system according to claim 26, wherein
the forward mounting plate of the H-shaped rear mounting member defines upper and lower elongate windows respectively aligned with the upper and lower rectilinear gear tracks, and wherein
the pinion gears of the upper and lower pinion gear assemblies extend through the upper and lower elongate windows of the forward mounting plate so as to be meshed with the upper and lower rectilinear gear tracks, respectively.

29. The modular electrical and/or data distribution rail system according to claim 28, wherein the pinion gear of a first one of the upper and lower pinion gear assemblies is motor-driven, and the pinion gear of a second one of the upper and lower pinion gear assemblies is an undriven follower gear.

30. The modular electrical and/or data distribution rail system according to claim 21, further comprising a temporary structural interface (TSI) module adapted to mount an accessory to the rail assembly, wherein the TSI module comprises:
(i) a housing which includes a quick-disconnect socket assembly configured to receive a quick-disconnect pin associated with the accessory,
(ii) an elongate back plate configured to be received within the elongate front slot of the support structure, and
(iii) a pair of rotatable wing members rotatably attached to the elongate back plate to allow for turning movements between an unlocked condition whereby each of the wing members is aligned with an elongate axis of the front slot and a locked condition whereby each of the wing members extends at substantially a right angle to the elongate axis of the front slot to thereby positionally lock the TSI module to the support structure of the rail assembly.

31. The modular electrical and/or data distribution rail system according to claim 30, wherein the housing comprises tool sockets each being operatively connected to a respective one of the wing members, the tool sockets being configured to accept a turning tool therein to assist in the turning movements of the wing members between the unlocked and locked conditions thereof.

32. The modular electrical and/or data distribution rail system according to claim 30, wherein
one of the electrical conductors of the rail assembly is an electrical power conductor and another one of the electrical conductors of the rail assembly is an electrical ground conductor, and wherein
each of the rotatable wing members comprise connector pins adapted to being connected to the one and another of the electrical conductors when the wing members are in the locked condition thereof, and wherein
the housing member comprises an electrically conductive path to electrically interconnect the connector pins to the respective electrical conductors of the rail assembly to the quick-disconnect socket assembly to thereby provide electrical power to the accessory when the quick-disconnect pin thereof is connected to the quick-disconnect socket.

33. An aircraft comprising a fuselage including an interior aircraft cabin which comprises the modular electrical and/or data distribution rail system according to claim 21.

34. A modular rail system comprising:
a rail assembly which includes an elongate support structure defining a C-shaped channel track defining an elongate front slot, and a plurality of electrical conductors carried by the elongate support structure; and
temporary structural interface (TSI) module adapted to mount an accessory to the rail assembly, wherein the TSI module comprises:
(i) a housing which includes a quick-disconnect socket assembly configured to receive a quick-disconnect pin associated with the accessory,
(ii) an elongate back plate configured to be received within the elongate front slot of the support structure, and
(iii) a pair of rotatable wing members rotatably attached to the elongate back plate to allow for turning movements between an unlocked condition whereby each of the wing members is aligned with an elongate axis of the front slot and a locked condition whereby each of the wing members extends at substantially a right angle to the elongate axis of the front slot to thereby positionally lock the TSI module to the support structure of the rail assembly.

35. The modular rail system according to claim 34, wherein the housing comprises tool sockets each being operatively connected to a respective one of the wing members, the tool sockets being configured to accept a turning tool therein to assist in the turning movements of the wing members between the unlocked and locked conditions thereof.

36. The modular rail system according to claim 34, wherein
the rail assembly comprises a plurality of electrical conductors carried by the elongate support structure, wherein one of the electrical conductors is an electrical power conductor and another one of the electrical conductors is an electrical ground conductor, and wherein
each of the rotatable wing members comprise connector pins adapted to being connected to the one and another of the electrical conductors when the wing members are in the locked condition thereof, and wherein
the housing member comprises an electrically conductive path to electrically interconnect the connector pins to the respective electrical conductors of the rail assembly to the quick-disconnect socket assembly to thereby provide electrical power to the accessory when the quick-disconnect pin thereof is connected to the quick-disconnect socket.

37. An aircraft comprising an aircraft fuselage which includes an interior aircraft cabin comprising the modular rail system according to claim 34.
